(19) United States
(12) Patent Application Publication
(10) Pub. No.: US 2026/0319106 A1
(43) Pub. Date: Oct. 15, 2026

(54) CARRIER/POSITIONING FREQUENCY LAYER CONFIGURATION FOR CARRIER PHASE MEASUREMENT PERFORMED TOGETHER WITH LEGACY POSITIONING MEASUREMENT

(71) Applicant: Telefonaktiebolaget LM Ericsson (publ), Stockholm (SE)

(72) Inventors: Deep SHRESTHA, Linköping (SE); Muhammad Ali KAZMI, Reston, VA (US); Gustav LINDMARK, Linköping (SE); Xiaolin JIANG, Linköping (SE); Florent MUNIER, Västra Frölunda (SE); Ritesh SHREEVASTAV, Upplands Väsby (SE); Siva MURUGANATHAN, Stittsville (CA)

(73) Assignee: Telefonaktiebolaget LM Ericsson (publ), Stockholm (SE)

(21) Appl. No.: 19/484,604

(22) PCT Filed: May 14, 2024
(86) PCT No.: PCT/SE2024/050468

§ 371 Date: Nov. 14, 2025

Related U.S. Application Data
(60) Provisional application No. 63/466,577, filed on May 15, 2023.

(51) Int. Cl. G01S 19/43

(52) U.S. Cl. CPC G01S 19/43

(57) ABSTRACT

A communication device can obtain configuration information to perform a carrier phase measurement together with a time difference measurement. The communication device can further perform the carrier phase measurement together with the time difference measurement based on the configuration information. The communication device can further perform an operational task based on the carrier phase measurement and the time difference measurement.

### TECHNICAL FIELD

The present disclosure is related to wireless communication systems and more particularly to carrier/positioning frequency layer (“PFL”) configuration for carrier phase measurement performed together with legacy positioning measurement.

### BACKGROUND

The present disclosure is related to wireless communication systems and more particularly to carrier/positioning frequency layer (“PFL”) configuration for carrier phase measurement performed together with legacy positioning measurement.

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Positioning has been a topic in LTE standardization since 3GPP Release 9. The primary objective is to fulfill regulatory requirements for emergency call positioning.

Positioning in NR is proposed to be supported by the architecture shown in FIG. 1. LMF is the location node in NR. There are also interactions between the location node and the gNodeB via the NRPPa protocol. The interaction between the gNodeB and the device is supported via the Radio Resource Control (“RRC”) protocol.

### SUMMARY

According to some embodiments, a method of operating a communication device is provided. The method includes obtaining configuration information to perform a carrier phase measurement together with a time difference measurement. The method further includes performing the carrier phase measurement together with the time difference measurement based on the configuration information. The method further includes performing an operational task based on the carrier phase measurement and the time difference measurement.

According to other embodiments, a method of operating a network node is provided. The network node is configured to provide a location server. The method includes configuring a communication device to perform carrier phase difference measurement together with time difference measurement. The method includes transmitting an indication of information to the communication device to be considered while performing the carrier phase difference measurement together with the time difference measurement. The method includes receiving a measurement report from the communication device including the carrier phase measurement performed together with the time difference measurement.

Certain aspects of these embodiments may provide technical advantages. In some embodiments, carrier phase difference measurement is consistent as it is performed by the UE on a same carrier/PFL. The location server will know which carrier/PFL that was used. This is needed for location server in order to be able to compare measurements from different UEs, including positioning reference unit (“PRU”) UEs. Assistance and measurement configuration data is tailored for the case where the UE is configured to perform the time difference measurement such as the RSTD measurement together with the carrier phase difference measurement (e.g., the RSCPD measurement). The UE completes the RSCPD measurement together with RSTD measurement without additional delay.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a block diagram illustrating an example of NR architecture for supporting positioning in NR;

FIG. 3 is a graph illustrating an example of a carrier phase measurement subject to a transmission phase offset and a receive phase offset;

FIG. 4 is a flow chart illustrating an example of operations performed by a communication device in accordance with some embodiments;

FIG. 5 is a flow chart illustrating an example of operations performed by a network node in accordance with some embodiments;

FIG. 6 is a block diagram of a communication system in accordance with some embodiments;

FIG. 7 is a block diagram of a user equipment in accordance with some embodiments;

FIG. 8 is a block diagram of a network node in accordance with some embodiments;

FIG. 9 is a block diagram of a host, which may be an embodiment of the host of FIG. 6, in accordance with some embodiments;

FIG. 10 is a block diagram of a virtualization environment in accordance with some embodiments; and

FIG. 11 shows a communication diagram of a host communicating via a network node with a user equipment over a partially wireless connection in accordance with some embodiments.

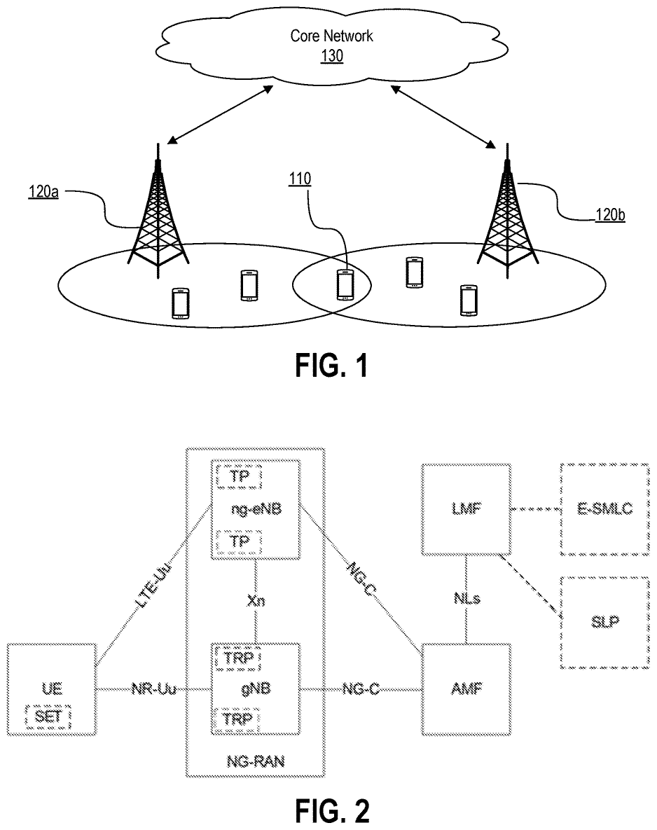

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

FIG. 2 illustrates an example of NR architecture for supporting NR positioning. In this example, the location node in NR is a location management function (“LMF”). There are also interactions between the location node and the gNodeB via the NR Positioning Protocol A (“NRPPa”). The interactions between the gNodeB and the device is supported via the Radio Resource Control (“RRC”) protocol, while the location node interfaces with the UE via the LTE Positioning Protocol (“LPP”). LPP is common to both NR and LTE. While FIG. 2 shows both a gNB and an ng-eNB, both may not always be present. Further, when both the gNB and the ng-eNB are present, the NG-C is generally only present for one of them.

LTE supports: 1) an enhanced cell identifier (“ID”); 2) assisted global navigation satellite system (“GNSS”); 3) observed time-difference-of-arrival (“OTDOA”); 4) uplink (“UL”) time-difference-of-arrival (“TDOA”); and 5) sensor techniques. Enhanced cell ID includes cell ID information to associate the device to the serving area of a serving cell, and then additional information to determine a finer granularity position. Assisted GNSS information can be retrieved by the device and supported by assistance information provided to the device from (“E-SMLC”). OTDOA includes the device estimating the time difference of reference signals from different base stations and sending the information to the E-SMLC for multilateration.

UTDOA includes the device requesting to transmit a specific waveform that is detected by multiple location measurement units (e.g., an eNB) at known positions. These measurements are forwarded to E-SMLC for multilateration. LTE sensor techniques can include a Biometric pressure sensor that provides vertical position of the device and an Inertial Motion Unit (“IMU”) that provides displacement.

In comparison to LTE, NR positioning benefits from larger bandwidth and finger beamforming and can localize a UE with higher accuracy. NR currently supports the following radio access technology (“RAT”) dependent positioning procedures: 1) Downlink time-difference-of-arrival (“DL-TDOA”); 2) Multi-round trip time (“RTT”); 3) Uplink time-difference-of-arrival (“UL-TDOA”); 4) Downlink angle-of-departure (“DL-AoD”); 5) Uplink angle-of-arrival (“UL-AoA”); and 6) NR enhanced cell identifier (“NR-ECID”).

The DL TDOA positioning procedure makes use of the downlink (“DL”) reference signal time difference (“RSTD”) (and optionally DL positioning reference signal (“PRS”) reference signal received power (“RSRP”)) of downlink signals received from multiple transmission points (“TPs”), at the UE. The UE measures the DL RSTD (and optionally DL PRS RSRP) of the received signals using assistance data received from the positioning server, and the resulting measurements are used along with other configuration information to locate the UE in relation to the neighboring TPs.

The Multi-RTT positioning procedure makes use of the UE reception (“Rx”)-transmission (“Tx”) measurements and DL PRS RSRP of downlink signals received from multiple transmission/reception points (“TRPs”), measured by the UE and the measured gNB Rx-Tx measurements and UL sounding reference signal (“SRS”)-RSRP at multiple TRPs of uplink signals transmitted from UE.

The UL TDOA positioning procedure makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

The DL AoD positioning procedure makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

The UL AoA positioning procedure makes use of the measured azimuth and zenith of arrival at multiple reception points (“RPs”) of uplink signals transmitted from the UE. The RPs measure A-AoA and Z-AoA of the received signals using assistance data received from the positioning server, and the resulting measurements are used along with other configuration information to estimate the location of the UE.

NR-ECID positioning refers to techniques that use additional UE measurements and/or NR radio resource and other measurements to improve the UE location estimate.

The positioning modes can be categorized into three areas: 1) UE-Assisted; 2) UE-Based; and 3) Standalone. UE-Assisted can refer to the UE performing measurements with or without assistance from the network and sending these measurements to the E-SMLC where the position calculation may take place. UE-Based can refer to the UE performing measurements and calculating its own position with assistance from the network. Standalone can refer to the UE performing measurements and calculating its own without network assistance.

There currently exist certain challenges. For reference signal time difference (“RSTD”) measurements, a location management function (“LMF”) provides the following information as a part of assistance data for positioning measurements: 1) a positioning reference signal (“PRS”) identifier (“ID”); 2) a PRS set ID; and a PRS resource ID. Upon receiving assistance data, a UE can perform RSTD measurements on reference and neighbor transmission/reception points (“TRPs”) and report them to the LMF for position estimation.

The RSTD measurement can be performed by the UE either by considering a reference TRP indicated in the assistance data or by selecting one of the TRPs in the assistance data as a reference TRP and reporting the performed RSTD measurements to the LMF. In the assistance data provided to the UE by LMF there is no indication of a positioning frequency layer (“PFL”) to be considered by the UE while performing the RSTD measurement. In this regard, the UE is free to select a reference TRP and a PFL to be considered while performing the RSTD measurement during a positioning session, where the reference TRP and the neighbor TRP can be in different PFLs.

It is unclear how to determine the PFL for carrier phase measurement and/or carrier phase difference measurement.

Certain aspects of the disclosure and their embodiments may provide solutions to these or other challenges. In some embodiments, the UE performs the carrier phase difference measurement on the reference signals of the same carrier/PFL operated by the reference TRP and the neighbor TRP. The time difference measurement such as RSTD measurement to be reported with the carrier phase difference measurement (e.g., as reference signal carrier phase difference (“RSCPD”)) is performed on the same carrier/PFL on which the UE performs the RSCPD. Signaling details between the location server and the UE are disclosed when the UE is configured to perform carrier phase difference and time difference measurements together. The UE behavior is disclosed when carrier phase difference and time difference measurements cannot be performed together by the UE.

A timing measurement used for UE positioning can be unidirectional or it can be bidirectional. Unidirectional timing measurement can be used by a first node (Node1) for measuring transmit timing of signal transmitted by Node1 or for measuring reception timing of signal received by Node1 from a second node (Node2). Bidirectional timing measurement can be used by Node1 for measuring a relationship between the transmit timing of a signal transmitted by Node1 and the reception timing of a signal received at Node1 from Node2. An example of the relationship is the difference between the transmission and the reception timings. In one example, Node1 may measure the absolute reception timing of the signal and/or it may measure reception timing of the signal with regards to a reference time. In additional or alternative examples, Node1 may measure the absolute transmit timing of the signal and/or it may measure the transmit timing of the signal with regards to a reference time.

In new radio (“NR”), several timing measurements for positioning are specified. An example of bidirectional timing measurement is round trip time (“RTT”). Specific examples of bidirectional timing measurements are UE receive-transmit (“Rx-Tx”) time difference, gNB Rx-Tx time difference, and time advance (“TA”). Examples of unidirectional timing measurements are reference signal time difference (“RSTD”) performed by the UE, and uplink (“UL”) relative time of arrival (“RTOA”) performed by the base station.

The following NR positioning measurements related to timing performed by the UE are specified: RSTD; and UE Rx-Tx time difference.

RSTD is a reference signal time difference between the positioning node j and the reference positioning node i. It is measured on the downlink (“DL”) positioning reference signal (“PRS”) signals and always involves two cells (cell is sometime used interchangeably herein with TRP).

The UE Rx-Tx time difference can be defined as T_{UE-RX}-T_{UE-TX,}. T_{UE-RX} is the UE received timing of downlink subframe #i from a positioning node, defined by the first detected path in time. It is measured on PRS signals received from the gNB. T_{UE-TX} is the UE transmit timing of uplink subframe #j that is closest in time to the subframe #i received from the positioning node.

The following NR positioning measurements related to timing performed by the base station (e.g., gNB) are specified: gNB Rx-Tx time difference; TA; and UL RTOA.

The gNB Rx-Tx time difference can be defined as T_{gNB-RX}-T_{gNB-TX}. T_{gNB-RX} is the positioning node received timing of uplink subframe #i containing SRS associated with UE, defined by the first detected path in time. It is measured on SRS signals received from the UE. T_{gNB-TX} is the positioning node transmit timing of downlink subframe #j that is closest in time to the subframe #i received from the UE.

The TA (T_{ADV}) can be defined as the time difference T_{ADV}=(T_{gNB-RX}-T_{gNB-TX}). T_{gNB-RX} is the Transmission and Reception Point (TRP) [18] received timing of uplink subframe #i containing PRACH transmitted from UE, defined by the first detected path in time. T_{gNB-TX} is the TRP transmit timing of downlink subframe #j that is closest in time to the subframe #i received from the UE. The detected PRACH is used to determine the start of one subframe containing that PRACH.

The UL RTOA can be defined as the beginning of subframe i containing SRS received in positioning node j, relative to the configurable reference time. For example, node1 (e.g., base station) measures the reception time of signals transmitted by the UE with regards to a reference time.

Assuming a link with one transmitter and one receiver, the transmitted pass-band signal can be given by:

x_{pb}(t)=s(t)exp(j2πf_{c}t+jφ₀),

where s(t) denotes the baseband signal and fc denotes the carrier frequency. The term φ₀ is an offset due to Tx imperfect synchronization, it includes the RF phase-difference compared to an ideal oscillator.

Assuming line-of-sight (“LOS”) conditions and no multipath, the channel can be given by:

h(t)=δ(t−τ₀),

where τ₀=d/c is the transition delay, c the speed of light and d the length of the LOS path between the transmitter and the receiver. The received passband-signal is the convolution:
y_{pb}(t)=h*x(t)=s(t−τ₀)exp(j2πf_{c}(t−τ₀)+jφ₀).

After down-conversion, the received baseband signal is:

y_{bb}(t)=y_{pb}(t)exp(−j2πf_{c}t−jφ₁)=s(t−τ₀)exp(−j2πf_{c}τ₀+j(φ₀−φ₁)),

where the term φ₁ is an offset due to Rx imperfect synchronization, it includes the RF phase-difference compared to an ideal oscillator. A carrier phase measurement of this transmission will return the phase:

Φ=−2πf_{c}τ₀+(φ₀−φ₁)+2πN∈[0, 2π], N∈Z. (1)

Above, the term 2πN corresponds to a modulus operation such that the measured phase is in the range [0, 2π].

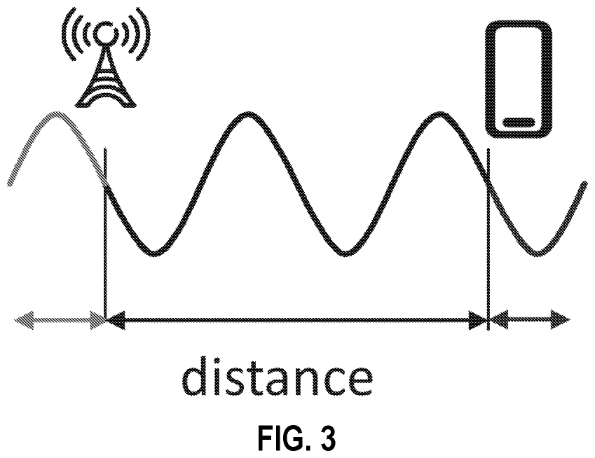

FIG. 3 illustrates an example of a carrier phase measurement subject to a transmission phase offset and a receive phase offset.

In the following, the terms “Tx phase offset” or “transmission phase offset” are used for φ₀, and the terms “Rx phase offset” or “receive phase offset” are used for φ₁.

For positioning, the following carrier phase measurements can be used: Carrier phase measurement; and Carrier phase difference measurement.

Carrier phase measurement can include a phase measurement of the carrier/PFL used by TRP for reference signal transmission. An example of the carrier phase measurement is Reference Signal Carrier Phase (“RSCP”).

Carrier phase difference measurement can include a difference of carrier phase measurements of carriers/PFLs used by reference TRP and neighbor TRP for reference signal transmission. Assuming that the carrier phase measured by the UE on a reference signal transmitted on a carrier/PFL operated by the reference TRP is Φ_{R} and the carrier phase measured by the UE on a reference signal transmitted on a carrier/PFL operated by the neighbor TRP is Φ_{N}, then the carrier phase difference measurement (“CPDM”) can be expressed as (Φ_{R}−Φ_{N}). In additional or alternative examples, the CPDM can be expressed as (Φ_{N}−Φ_{R}). The CPDM may also be indicated as the absolute value (e.g., |(Φ_{R}−Φ_{N})| or |(Φ_{N}−Φ_{R})|). The CPDM may also be referred to as a carrier phase differential measurement, a carrier phase relative measurement, and a relative carrier phase measurement. In some examples, the carrier phase difference measurement is a Reference Signal Carrier Phase Difference (“RSCPD”).

Carrier phase and carrier phase difference measurement can be performed by a UE on a carrier/PFL used by a TRP to transmit reference signals such as PRS, CSI-RS, and CS-RS. The carrier phase or the carrier phase difference measurement can be expressed in units of degrees (e.g., π/6, π/3, and π/2).

In some embodiments, a UE obtains information about at least one carrier/PFL autonomously based on a criterion or by receiving information from the location server (e.g., a LMF) for carrier phase difference measurements such as RSCPD measurements. The indicated carrier/PFL is common between the reference TRP and neighbor TRP.

In some examples of autonomous selection of the carrier/PFL, the UE obtains configuration from the location server (e.g., a LMF) including two or more carriers/PFLs and selects at least one of the configured carriers/PFLs for carrier phase difference measurement such as RSCPD measurement. In some examples of the criterion, the UE selects the at least one carrier/PFL for performing the RSCPD measurement that is common between the reference TRP and neighbor TRP. In additional or alternative examples of the criterion, the UE selects the same carrier frequency/PFL for performing the RSCPD and the RSTD if the UE is configured to report the RSCPD together with the RSTD. In this example, the UE performs both the RSCPD and the RSTD by measuring reference signals (e.g. PRS) transmitted by the reference TRP and the neighboring TRP on the same/common carrier/PFL.

In additional or alternative embodiments, the UE performs carrier phase difference measurement such as RSCPD and time difference measurement such as RSTD measurements on the obtained carrier/PFL (e.g., autonomously or based on the indication received by location server (e.g., LMF)). The UE can use the performed/obtained measurement results for performing one or more operational tasks.

Examples of the tasks include: the UE using the results for determining the UE positioning and the UE reporting RSCPD measurement together with RSTD measurement in its measurement report to location server. In the measurement report, the UE can indicate to a location server which carrier/PFL was selected by the UE and used by the UE for the measurement. The indicated carrier/PFL can be the one indicated by the location server in assistance data or the carrier/PFL selected by the UE out of the carriers/PFLs configured by location server. In both cases the indicated carrier/PFL can be common between the reference TRP and neighbor TRP (e.g., the RSCPD is measured on the reference signal (e.g., PRS) transmitted on the same carrier frequency by the reference TRP and the neighbor TRP).

In additional or alternative embodiments, the UE is configured by a location server (e.g., a LMF) or the UE determines based on a pre-defined rule, the fallback behavior of the UE should it fail to perform the RSCPD measurement on the carrier/PFL indicated by the location server.

In some examples, if the UE cannot perform RSCPD measurement on the carrier/PFL indicated by the location server then the UE only reports RSTD measurement results to the location server. For example, this case may be regarded as a partial measurement failure i.e. failure of the RSCPD only. The UE may fail to perform the RSCPD for example if the UE cannot detect the carrier phase or cannot reliably detect the carrier phase of the reference signal transmitted by the reference TRP and/or of the reference signal transmitted by the neighboring TRP. The estimated/measured carrier phase is reliable or the carrier phase difference is reliable if it is within an expected carrier phase value or within an expected carrier phase difference value (e.g. configured by the location server).

In additional or alternative examples, if the UE cannot perform RSTS measurement on the carrier/PFL indicated by the location server then the UE does not report RSCPD measurement results to the location server even if the UE has measured the RSCPD. For example, in this case the UE declares measurement failure i.e. failure of both the RSCPD and the RSTD. The UE may fail to perform the RSTS for example if the estimated RSTD is outside an expected RSTD value (e.g. configured by the location server).

In some embodiments, a communications network can include a UE, a first network node (“NW1”) (which can be serving a TRP, a reference TRP, or a neighbor TRP transmitting reference signal for positioning measurements such as PRS), and a second network node (“NW2”) (which can be a location server that provides assistance data to the UE for positioning measurement).

Positioning measurements can be one of a RSTD, a UE Rx-Tx, RSTD+carrier phase difference, or a UE Rx-Tx+carrier phase measurement. The UE may also interchangeably be referred to as a target device or a wireless device. The TRP may also interchangeably be referred to as a base station, access point, gNB, eNB, satellite access node (“SAN”), high altitude platform station (“HAPS”), and integrated access and backhaul (“IAB”) node. The location server may also interchangeably be referred to as a positioning node, a SMLC, an E-SMLC, and a LMF. NW2 provides assistance data to UE via higher layer signaling (e.g., LPP messages). The UE reports positioning measurement to NW2 after performing the positioning measurement based on the configuration/assistance data provided to the UE by NW2. The UE can be in any of the RRC states (e.g., either of RRC_CONNECTED, RRC_INACTIVE, and RRC_IDLE states), when performing the positioning measurements configured by NW2. The assistance data provided by NW2 to the UE remains valid regardless of RRC state of the UE while the UE is performing positioning measurements configured by NW2. NW2 is aware of PFL used by NW1 to transmit reference signal for positioning measurements.

The term positioning frequency layer (“PFL”) can be referred to herein as a carrier frequency, a component carrier (“CC”), a frequency layer, a serving carrier, or a frequency channel. The PFL belongs to a certain frequency band, which may include one or multiple PFLs/carrier frequencies based on its passband (e.g., size of the band in frequency domain) and/or bandwidth of the carriers and/or the channel raster. The PFL/carrier frequency related information is transmitted to the UE by a network node using a channel number or identifier via a message (e.g., RRC). Examples of the channel number or identifier, which may be pre-defined, are absolute radio frequency channel number (“ARFCN”), NR-ARFCN, PFL identifier, absoluteFrequencyPointA (the absolute frequency position of the reference resource block), and number of PRBs.

In some embodiments, a UE can receive and use a carrier/PFL indication in assistance data for a carrier phase measurement from a location server. In some examples, the UE receives PFL configuration to be considered for carrier phase measurement in assistance data from the location server (e.g., a LMF). In this example, the UE is configured by a location server to perform a carrier phase measurement such as a carrier phase difference measurement together with a time difference measurement such as a RSTD.

In additional or alternative examples, the UE obtains configuration information (e.g., assistance data) to perform carrier phase measurement such as carrier phase difference measurement (“CPDM”) together with time difference measurement such as RSTD. The configuration information may indicate one or more PFLs on which the UE is required to perform the CPDM. The UE obtains the configuration information by receiving a message or the UE obtains the configuration information autonomously or based on a rule at least in part or partially.

In one option, the UE receives a message from NW2 (e.g. location server) indicating information about the carrier/PFL to be considered/used while performing carrier phase measurement such as carrier phase difference measurement together with time difference measurement such as RSTD. In this step UE receives from NW2 an indication of a single carrier/PFL that is common between reference and neighbor TRP or list of TRPs or list of PRS IDs to be considered by UE while performing carrier phase measurement such as carrier phase difference measurement together with time difference measurement such as RSTD. An explicit indication of reference TRP or PRS ID may not be signaled by NW2 to the UE in this step.

In an additional or alternative option, the UE does not receive from NW2 an indication of carrier/PFL to be considered while performing carrier phase measurement (CPDM) such as carrier phase difference measurement together with time difference measurement such as RSTD. Instead, the UE is configured by NW2 to select one of the carriers/PFLs to perform measurements. The UE is therefore configured by NW2 with at least two carriers/PFLs out of which the UE itself selects at one of the carriers/PFLs for the CPDM. Therefore, the UE in this case autonomously selects same carrier/PFL in both the reference TRP and the neighbor TRP to perform carrier phase measurement such as carrier phase difference measurement together with time difference measurement such as RSTD. The UE however receives an assistance data from NW2 indicating the UE to perform the CPDM measurement together with the RSTD.

In additional or alternative examples, the UE performs carrier phase measurement such as carrier phase difference measurement together with time difference measurement such as RSTD based on the obtained configuration information in the previous steps. The joint CPDM and the RSTD are performed by the UE by considering one of the TRPs or dl-PRS-IDs in the PFL in the assistance data as reference TRP. In this step UE may select TRP or dl-PRS-IDs that may or may not belong to its serving cell.

In additional or alternative examples, the UE uses the obtained CPDM and the RSTD results for performing one or more operational tasks (e.g., reports the results of the carrier phase difference measurement together with timing difference measurement to NW2, or use the results of the performed measurements for determining the positioning of the UE).

In additional or alternative embodiments, multiple carriers/PFLs are used to measure a list of carrier phase difference measurements.

In some examples, the UE is configured by location server to perform time difference measurements such as RSTD. The UE measures and reports multiple RSTD measurements (e.g., via the list nr-DL-TDOA-MeasList-r16 in the information element NR-DL-TDOA-SignalMeasurementInformation defined in 3GPP TS 37.355v17.4.0 ). The multiple RSTD measurements are with respect to the “RSTD reference” TRP given by dl-PRS-ReferenceInfo in information element NR-DL-TDOA-SignalMeasurementInformation.

In additional or alternative examples, the location server configures the UE to perform carrier phase difference measurement together with the time difference measurements such as RSTD. In one case, for each of the multiple RSTD measurements in the list nr-DL-TDOA-MeasList-r16, the UE reports the corresponding carrier phase difference measurement such as RSCPD measurement.

In additional or alternative examples, the UE includes the RSCPD measurements in the nr-DL-TDOA-MeasElement-r16 together with the DL RSTD measurement. Second alternative is that the UE may report another list with the RSCPD measurements, wherein each element in the list has a corresponding element in nr-DL-TDOA-MeasList-r16.

The same reference TRP (e.g., “RSTD reference” TRP given by dl-PRS-ReferenceInfo) is used for all the RSTD measurements and the RSCPD measurements.

Considering the nth RSTD measurement element in the list nr-DL-TDOA-MeasList-r16 and the corresponding nth RSCPD measurement in the new list with RSCPD measurements, the carrier/PFL for the nth RSCPD measurement is determined as follows: 1) the reference carrier phase measured on the reference TRP is measured using the same carrier/PFL as the one used to measure the neighbor TRP given by the ‘dl-PRS-ID-r16’ in the nth RSTD measurement element in the list nr-DL-TDOA-MeasList-r16; 2) the carrier phase measured on the neighbor TRP uses the same carrier/PFL as the one used to measure the neighbor TRP given by the ‘dl-PRS-ID-r16’ in the nth RSTD measurement element in the list nr-DL-TDOA-MeasList-r16; and 3) the nth RSCPD measurement is then determined by the difference between the neighbor TRP carrier phase end the reference carrier phase. In additional or alternative examples, which carrier/PFL is used to measure the reference carrier phase and the neighbor TRP carrier phase of the nth RSCPD measurement is implicitly determined by the carrier/PFL used to measure the neighbor TRP in the nth RSTD measurement.

In additional or alternative embodiments, assistance data is provisioned for carrier phase measurement to UE.

In some examples, location server, NW2, indicates carrier/PFL to be considered for carrier phase measurement such as carrier phase difference measurement together with time difference measurement such as RSTD in assistance data to UE. In this example location server, NW2, configures UE to perform carrier phase measurement such as carrier phase difference measurement together with time difference measurement such as RSTD.

In additional or alternative examples, NW2 configures UE to perform carrier phase difference measurement together with time difference measurement such as RSTD.

In one option, NW2 indicates PFL to be considered while performing carrier phase difference measurement together with time difference measurement such as RSTD. In this step NW2 indicates carrier/PFL or list of TRPs or list of PRS IDs to be considered by UE while performing carrier phase difference measurement together with time difference measurement such as RSTD. An explicit indication of reference TRP or PRS ID is not done by NW2.

In an additional or alternative option, NW2 does not indicate carrier/PFL to be considered while performing carrier phase difference measurement such as RSCPD together with time difference measurement such as RSTD. Instead, NW2 indicates that it is up to the UE to decide carrier/PFL, but that the PFL must be same in the reference TRP and neighbor TRP.

In additional or alternative examples, NW2 receives measurement report from UE. The measurement report contains carrier phase difference measurement performed together with time difference measurement such as RSTD. NW2 also receives an indication of carrier/PFL used to perform carrier phase difference measurement together with time difference measurement.

In additional or alternative embodiments, a TRP indication is included in assistance data for carrier phase measurement.

In some examples, the UE is indicated TRP to be considered for carrier phase measurement in assistance data. In this example, UE is configured to perform carrier phase measurement such as carrier phase difference measurement together with time difference measurement is considered.

In additional or alternative examples, the UE receives assistance data from NW2 to perform carrier phase difference measurement together such as RSCPD with time difference measurement such as RSTD by considering the reference TRP and neighbor TRP indicated in the assistance data.

In some options, NW2 configures UE to perform carrier phase difference measurement together such as RSCPD with time difference measurement such as RSTD.

In additional or alternative options, NW2 configures UE to indicate that, should carrier phase difference measurement fail using the indicated assistance data, UE may report time difference measurement such as RSTD measurement alone, without carrier phase difference measurement such as RSCPD.

In additional or alternative options, NW2 indicates reference TRP to be considered while performing carrier phase difference measurement together with time difference measurement. In this step NW2 does not explicitly indicate carrier/PFL but implicitly does so by indicating reference TRP via dl-PRS-ID to be considered by UE while performing carrier phase difference measurement together with time difference measurement. NW2 along with dl-PRS-ID of reference TRP also indicates dl-PRS-ID s of neighbor TRPs to be considered by UE while performing carrier phase difference measurement together with time difference measurement.

In some examples, NW2 may indicate one list of dl-PRS-IDs of reference TRP and neighbor TRPs corresponding to one carrier/PFL.

In additional or alternative examples, NW2 may indicate multiple([2,4]) lists of dl-PRS-IDs of reference TRP and neighbor TRPs, and each list corresponds to one carrier/PFL. In this case, UE can choose one list.

In some options (without indication of time difference-only measurement report as fall back), the UE reports carrier phase difference measurement together with time difference measurement to NW2. In the measurement report, if UE can choose one out of multiple carriers/PFLs for carrier phase difference measurement, UE indicates the carrier/PFL it used for carrier phase difference measurement such as RSCPD measurement, e.g., the carrier/PFL information can be obtained from dl-PRS-IDs of reference TRP. If UE could not detect reference TRP indicated in the assistance data, then UE selects one of the TRPs in assistance data as reference TRP and reports only time difference measurement such as RSTD measurement.

In additional or alternative options (with indication of time difference-only measurement report as fall back), the UE reports carrier phase difference measurement together with time difference measurement to NW2. In the measurement report, if UE can choose one out of multiple carriers/PFLs for carrier phase difference measurement, UE indicates the carrier/PFL it used for carrier phase difference measurement such as RSCPD, e.g., the carrier/PFL information can be obtained from dl-PRS-IDs of reference TRP. If UE could not detect reference TRP indicated in the assistance data, and the UE is indicated that NW2 may receive only time difference measurement such as RSTD measurement if no carrier phase difference measurement can be performed, then UE selects one of the TRPs in assistance data as reference TRP and reports only time difference measurement. If the UE is indicated that NW2 is not interested in time difference (e.g. RSTD) only measurement, the UE reports measurement failure.

In some embodiments, the UE receives assistance data from NW2 to perform carrier phase difference measurement such as RSCPD together with time difference measurement such as RSTD, but is not able to perform measurements. According to the invention, the following steps are performed by UE NW2.

In some examples, the UE receives assistance data from NW2. If UE could not receive reference signal for positioning in carrier/PFL indicated in assistance data or reference TRP indicated in assistance data or reference PRS ID indicated in assistance data UE does not perform carrier phase difference measurement or time difference measurement or carrier phase difference measurement together with time difference measurement and reports measurement failure to NW2.

In additional or alternative examples, the UE requests an updated assistance to perform carrier phase difference measurement such as RSCPD together with time difference measurement such as RSTD.

In additional or alternative examples, the UE receives an updated assistance data from NW2. UE performs carrier phase difference measurement such as RSCPD together with time difference measurement such as RSTD and reports them to NW2.

In some embodiments, NW2 while configuring assistance data for carrier phase difference measurement provides a default or first configured carrier/PFL to be used as reference carrier/PFL. In such case, UE does not report any carrier/PFL which was used for measurement as it is implicitly derived by NW2.

In some examples, NW2 may also provide a restricted configuration where only one carrier/PFL is configured when Carrier phase difference measurement together with time difference measurement is required for positioning. In such a restricted case also, it is implicitly derived.

In additional or alternative examples, NW2 may also provide a preferred carrier/PFL for Carrier phase measurement. Hence, the UE would perform the carrier phase measurement in such prioritized carrier/PFL which may be different carrier/PFL where time difference measurement such as RSTD is performed.

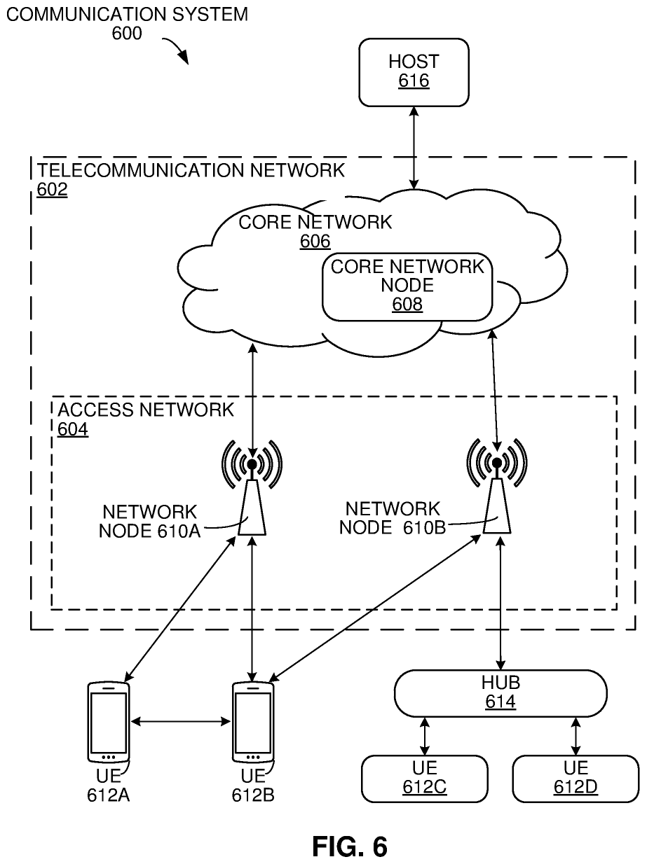

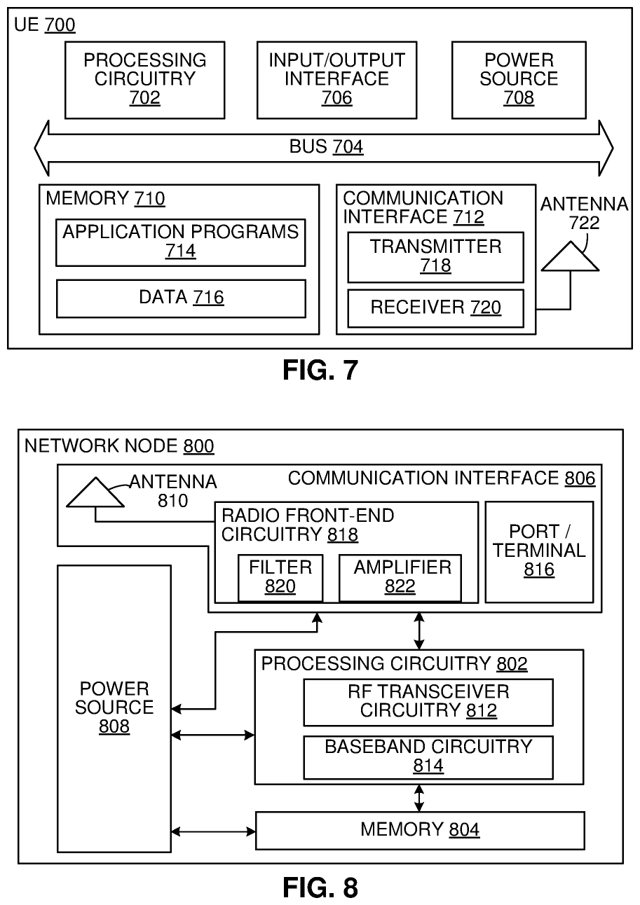

Operations of the communication device 700 (implemented using the structure of FIG. 7) will now be discussed with reference to the flow chart of FIG. 6 according to some embodiments of inventive concepts. For example, modules may be stored in memory 710 of FIG. 7, and these modules may provide instructions so that when the instructions of a module are executed by respective communication device processing circuitry 702, communication device 700 performs respective operations of the flow chart.

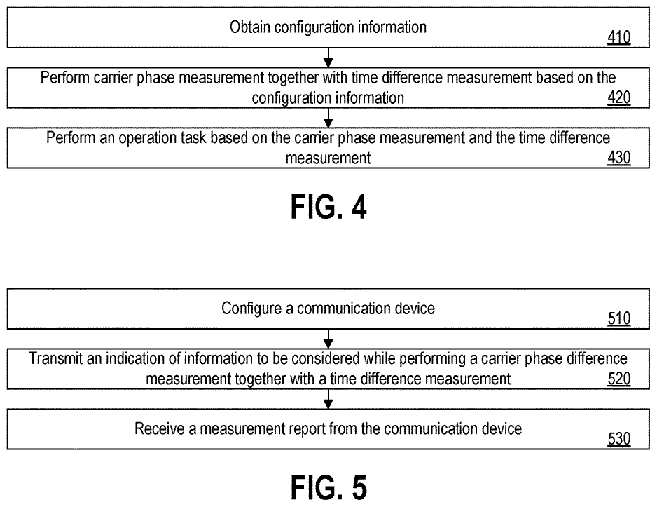

FIG. 4 illustrates an example of operations performed by a communication device.

At block 410, processing circuitry 702 obtains configuration information. The configuration information can be used to perform a carrier phase measurement together with a time difference measurement. In some embodiments, obtaining the configuration information includes receiving a message from a network node configured to provide a location server. In additional or alternative embodiments, obtaining the configuration information includes determining the configuration information from a list of potential configuration informations.

At block 420, processing circuitry 702 performs carrier phase measurement together with time difference measurement based on the configuration information. In some examples, the carrier phase measurement includes a carrier phase difference measurement, CPDM. The time difference measurement includes a reference signal time difference, RSTD.

In additional or alternative embodiments, the configuration information includes an indication of a positioning frequency layer, PFL, on which the communication device is instructed to perform the carrier phase measurement. In some examples, the PFL includes a single PFL that is common between a reference node and a neighbor node that is to be considered while performing the carrier phase measurement. In additional or alternative examples, the reference node is a reference transmission-reception point, TRP. In additional or alternative examples, the neighbor node is a neighbor TRP.

In additional or alternative embodiments, performing the carrier phase measurement together with the time difference measurement includes: 1) measuring a reference carrier phase on the reference TRP using a carrier/PFL used to measure the neighbor TRP; 2) measuring carrier phase on the neighbor TRP using the carrier PFL used to measure the neighbor TRP; and 3) determining a reference signal carrier phase difference, RSCPD, measurement based on a difference between the carrier phase and the reference carrier phase.

In additional or alternative embodiments, performing the carrier phase measurement together with the time difference measurement includes: 1) failing to perform the carrier phase measurement or the time difference measurement; 2) requesting updated configuration information; and 3) reperforming the carrier phase measurement together with the time difference measurement.

At block 430, processing circuitry 702 performs an operation task based on the carrier phase measurement and the time difference measurement. In some embodiments, performing the operational task includes reporting a result of performing the carrier phase measurement together with the time difference measurement. In additional or alternative embodiments, performing the operational task includes determining a positioning of the communication device.

Various operations from the flow chart of FIG. 6 may be optional with respect to some embodiments of communication devices and related methods.

Operations of the RAN node 800 (implemented using the structure of FIG. 8) will now be discussed with reference to the flow charts of FIGS. 7-8 according to some embodiments of inventive concepts. For example, modules may be stored in memory 804 of FIG. 8, and these modules may provide instructions so that when the instructions of a module are executed by respective RAN node processing circuitry 802, RAN node 800 performs respective operations of the flow charts.

FIG. 5 illustrates an example of operations performed by a network node. In some examples, the network node is configured to provide a location server (e.g., a location management server).

At block 510, processing circuitry 802 configures a communication device, for example, to perform carrier phase difference measurement together with time difference measurement. In some embodiments, configuring the configuration information includes transmitting a list of potential configuration informations.

At block 520, processing circuitry 802 transmits, via communication interface 806, an indication of information to be considered while performing a carrier phase difference measurement together with a time difference measurement. In some examples, the carrier phase measurement includes a carrier phase difference measurement, CPDM. In additional or alternative examples, the time difference measurement comprises a reference signal time difference, RSTD.

In some embodiments, the configuration information includes an indication of a positioning frequency layer, PFL, on which the communication device is instructed to perform the carrier phase measurement. In additional or alternative embodiments, the PFL includes a single PFL that is common between a reference node and a neighbor node that is to be considered while performing the carrier phase measurement. In some examples, the reference node is a reference transmission-reception point, TRP. In additional or alternative examples, the neighbor node is a neighbor TRP.

At block 530, processing circuitry 802 receives, via communication interface 806, a measurement report from the communication device.

Various operations from the flow charts of FIGS. 7-8 may be optional with respect to some embodiments of RAN nodes and related methods.

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3rd Generation Partnership Project (3GPP) access node or non-3GPP access point. Moreover, as will be appreciated by those of skill in the art, the network nodes 610 are not necessarily limited to an implementation in which a radio portion and a baseband portion are supplied and integrated by a single vendor. Thus, it will be understood that the network nodes 610 may include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 610 facilitate direct or indirect connection of user equipment (UE), such as by connecting wireless devices 612a, 612b, 612c, and 612d (one or more of which may be generally referred to as UEs 612) to the core network 606 over one or more wireless connections. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub-that is, a hub whose primary function is to route communications to/from the UEs from/to the network node 610b. In other embodiments, the hub 614 may be a non-dedicated hub-that is, a device which is capable of operating to route communications between the UEs and network node 610b, but which is additionally capable of operating as a communication start and/or end point for certain data channels.

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708.

Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment.

Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

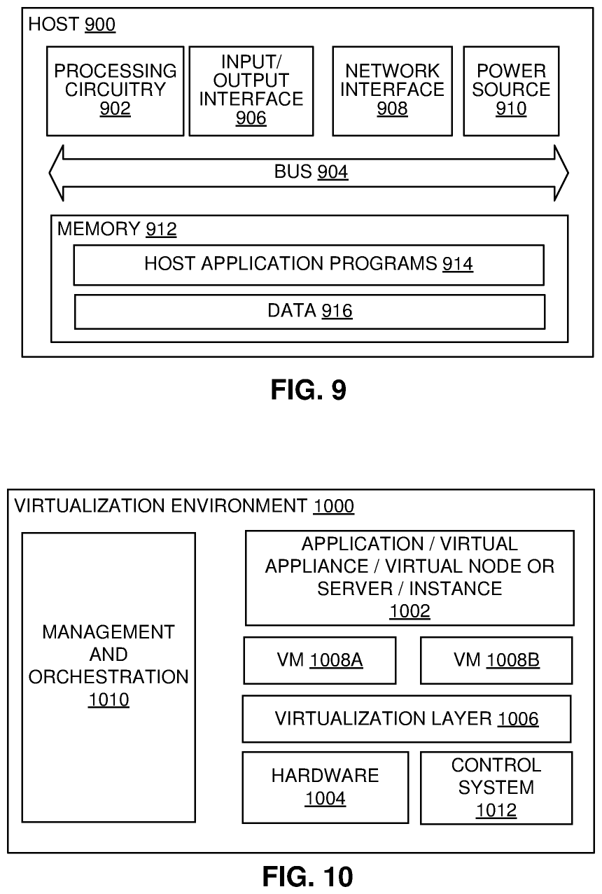

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1000 includes components defined by the O-RAN Alliance, such as an O-Cloud environment orchestrated by a Service Management and Orchestration Framework via an O-2 interface.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

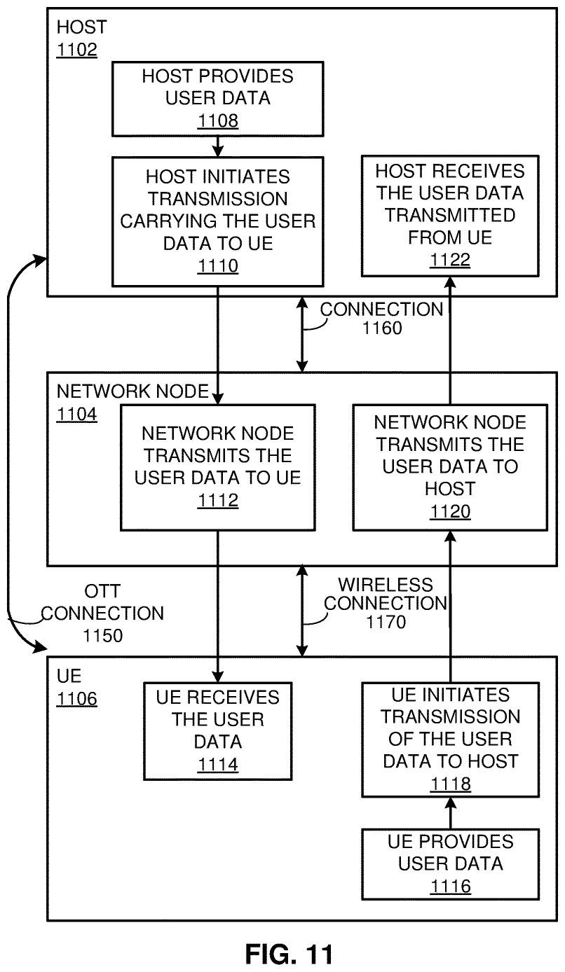

FIG. 11 shows a communication diagram of a host 1102 communicating via a network node 1104 with a UE 1106 over a partially wireless connection in accordance with some embodiments. Example implementations, in accordance with various embodiments, of the UE (such as a UE 612a of FIG. 6 and/or UE 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may allow a carrier phase difference measurement to be consistent as it is performed by UE on same carrier/PFL. A location server can know which carrier/PFL that was used. This can be useful for the location server in order to be able to compare measurements from different UEs, including PRU UEs. Assistance and measurement configuration data can be tailored for the case where UE is configured to perform time difference measurement such as RSTD measurement together with carrier phase difference measurement such as RSCPD measurement. The UE can complete RSCPD measurement together with RSTD measurement without additional delay.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments described below.

Embodiment 1. A method of operating a communication device, the method comprising:
obtaining (410) configuration information to perform a carrier phase measurement together with a time difference measurement;
performing (420) the carrier phase measurement together with the time difference measurement based on the configuration information; and
performing (430) an operational task based on the carrier phase measurement and the time difference measurement.

Embodiment 2. The method of Embodiment 1, wherein obtaining the configuration information comprises receiving a message from a network node configured to provide a location server.

Embodiment 3. The method of Embodiment 1, wherein obtaining the configuration information comprises determining the configuration information from a list of potential configuration informations.

Embodiment 4. The method of any of Embodiments 1-3, wherein the carrier phase measurement comprises a carrier phase difference measurement, CPDM, and wherein the time difference measurement comprises a reference signal time difference, RSTD.

Embodiment 5. The method of any of Embodiments 1-4, wherein the configuration information comprises an indication of a positioning frequency layer, PFL, on which the communication device is instructed to perform the carrier phase measurement.

Embodiment 6. The method of Embodiment 5, wherein the PFL comprises a single PFL that is common between a reference node and a neighbor node that is to be considered while performing the carrier phase measurement, wherein the reference node is a reference transmission-reception point, TRP, and wherein the neighbor node is a neighbor TRP.

Embodiment 7. The method of Embodiment 6, wherein performing the carrier phase measurement together with the time difference measurement comprises:
measuring a reference carrier phase on the reference TRP using a carrier/PFL used to measure the neighbor TRP;
measuring carrier phase on the neighbor TRP using the carrier PFL used to measure the neighbor TRP; and
determining a reference signal carrier phase difference, RSCPD, measurement based on a difference between the carrier phase and the reference carrier phase.

Embodiment 8. The method of Embodiment 1-7, wherein performing the carrier phase measurement together with the time difference measurement comprises:
failing to perform the carrier phase measurement or the time difference measurement; requesting updated configuration information; and
reperforming the carrier phase measurement together with the time difference measurement.

Embodiment 9. The method of any of Embodiment 1-7, wherein performing the operational task comprises reporting a result of performing the carrier phase measurement together with the time difference measurement.

Embodiment 10. The method of any of Embodiment 1-7, wherein performing the operational task comprises determining a positioning of the communication device.

Embodiment 11. A method of operating a network node configured to provide a location server, the method comprising:
configuring (510) a communication device to perform carrier phase difference measurement together with time difference measurement;
transmitting (520) an indication of information to the communication device to be considered while performing the carrier phase difference measurement together with the time difference measurement; and
receiving (530) a measurement report from the communication device including the carrier phase measurement performed together with the time difference measurement.

Embodiment 12. The method of Embodiment 11, wherein the network node is configured to provide a location server.

Embodiment 13. The method of any of Embodiments 11-12, wherein configuring the configuration information comprises transmitting a list of potential configuration informations.

Embodiment 14. The method of any of Embodiments 11-13, wherein the carrier phase measurement comprises a carrier phase difference measurement, CPDM, and
wherein the time difference measurement comprises a reference signal time difference, RSTD.

Embodiment 15. The method of any of Embodiments 11-14, wherein the configuration information comprises an indication of a positioning frequency layer, PFL, on which the communication device is instructed to perform the carrier phase measurement.

Embodiment 16. The method of Embodiment 15, wherein the PFL comprises a single PFL that is common between a reference node and a neighbor node that is to be considered while performing the carrier phase measurement,
wherein the reference node is a reference transmission-reception point, TRP, and
wherein the neighbor node is a neighbor TRP.

Embodiment 17. A communication device (700), the communication device comprising:
processing circuitry (702); and
memory (710) coupled to the processing circuitry and having instructions stored therein that are executable by the processing circuitry to cause the communication device to perform operations comprising any of the operations of Embodiments 1-10.

Embodiment 18. A computer program comprising program code to be executed by processing circuitry (702) of a communication device (700), whereby execution of the program code causes the communication device to perform operations comprising any operations of Embodiments 1-10.

Embodiment 19. A computer program product comprising a non-transitory storage medium (710) including program code to be executed by processing circuitry (702) of a communication device (700), whereby execution of the program code causes the communication device to perform operations comprising any operations of Embodiments 1-10.

Embodiment 20. A non-transitory computer-readable medium having instructions stored therein that are executable by processing circuitry (702) of a communication device (700) to cause the communication device to perform operations comprising any of the operations of Embodiments 1-10.

Embodiment 21. A network node (800), the network node comprising:
processing circuitry (802); and
memory (804) coupled to the processing circuitry and having instructions stored therein that are executable by the processing circuitry to cause the network node to perform operations comprising any of the operations of Embodiments 11-16.

Embodiment 22. A computer program comprising program code to be executed by processing circuitry (802) of a network node (800), whereby execution of the program code causes the network node to perform operations comprising any operations of Embodiments 11-16.

Embodiment 23. A computer program product comprising a non-transitory storage medium (804) including program code to be executed by processing circuitry (802) of a network node (800), whereby execution of the program code causes the network node to perform operations comprising any operations of Embodiments 11-16.

Embodiment 24. A non-transitory computer-readable medium having instructions stored therein that are executable by processing circuitry (802) of a network node (800) to cause the network node to perform operations comprising any of the operations of Embodiments 11-16.

Embodiment 25. A host configured to operate in a communication system to provide an over-the-top (OTT) service, the host comprising:

processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the operations of Embodiments 1-10 to receive the user data from the host.

Embodiment 26. The host of the previous embodiment, wherein the cellular network further includes a network node configured to communicate with the UE to transmit the user data to the UE from the host.

Embodiment 27. The host of the previous 2 embodiments, wherein:
the processing circuitry of the host is configured to execute a host application, thereby providing the user data; and
the host application is configured to interact with a client application executing on the UE, the client application being associated with the host application.

Embodiment 28. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of Embodiments 1-10 to receive the user data from the host.

Embodiment 29. The method of the previous embodiment, further comprising:
at the host, executing a host application associated with a client application executing on the UE to receive the user data from the UE.

Embodiment 30. The method of the previous embodiment, further comprising:
at the host, transmitting input data to the client application executing on the UE, the input data being provided by executing the host application,
wherein the user data is provided by the client application in response to the input data from the host application.

Embodiment 31. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the operations of Embodiments 1-10 to transmit the user data to the host.

Embodiment 32. The host of the previous embodiment, wherein the cellular network further includes a network node configured to communicate with the UE to transmit the user data from the UE to the host.

Embodiment 33. The host of the previous 2 embodiments, wherein:
the processing circuitry of the host is configured to execute a host application, thereby providing the user data; and
the host application is configured to interact with a client application executing on the UE, the client application being associated with the host application.

Embodiment 34. A method implemented by a host configured to operate in a communication system that further includes a network node and a user equipment (UE), the method comprising:
at the host, receiving user data transmitted to the host via the network node by the UE, wherein the UE performs any of the operations of Embodiments 1-10 to transmit the user data to the host.

Embodiment 35. The method of the previous embodiment, further comprising:
at the host, executing a host application associated with a client application executing on the UE to receive the user data from the UE.

Embodiment 36. The method of the previous embodiment, further comprising:
at the host, transmitting input data to the client application executing on the UE, the input data being provided by executing the host application,
wherein the user data is provided by the client application in response to the input data from the host application.

Embodiment 37. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of Embodiments 11-16 to transmit the user data from the host to the UE.

Embodiment 38. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 39. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of Embodiments 11-16 to transmit the user data from the host to the UE.

Embodiment 40. The method of the previous embodiment, further comprising, at the network node, transmitting the user data provided by the host for the UE.

Embodiment 41. The method of any of the previous 2 embodiments, wherein the user data is provided at the host by executing a host application that interacts with a client application executing on the UE, the client application being associated with the host application.

Embodiment 42. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of Embodiments 11-16 to transmit the user data from the host to the UE.

Embodiment 43. The communication system of the previous embodiment, further comprising:
the network node; and/or
the user equipment.

Embodiment 44. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of Embodiments 11-16 to receive the user data from a user equipment (UE) for the host.

Embodiment 45. The host of the previous 2 embodiments, wherein:
the processing circuitry of the host is configured to execute a host application, thereby providing the user data; and
the host application is configured to interact with a client application executing on the UE, the client application being associated with the host application.

Embodiment 46. The host of the any of the previous 2 embodiments, wherein the initiating receipt of the user data comprises requesting the user data.

Embodiment 47. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the operations of Embodiments 11-16 to receive the user data from the UE for the host.

Embodiment 48. The method of the previous embodiment, further comprising at the network node, transmitting the received user data to the host.

1. A method of operating a communication device, the method comprising:
obtaining configuration information to perform a carrier phase measurement together with a time difference measurement;
performing the carrier phase measurement together with the time difference measurement based on the configuration information; and
performing an operational task based on the carrier phase measurement and the time difference measurement.

2. The method of claim 1, wherein obtaining the configuration information comprises receiving a message from a network node configured to provide a location server.

3. The method of claim 1, wherein obtaining the configuration information comprises determining the configuration information from a list of potential configuration informations.

4. The method of claim 1, wherein the carrier phase measurement comprises a carrier phase difference measurement, CPDM, and wherein the time difference measurement comprises a reference signal time difference, RSTD.

5. The method of claim 1, wherein the configuration information comprises an indication of a positioning frequency layer, PFL, on which the communication device is instructed to perform the carrier phase measurement.

6. The method of claim 5, wherein the PFL comprises a single PFL that is common between a reference node and a neighbor node that is to be considered while performing the carrier phase measurement,
wherein the reference node is a reference transmission-reception point, TRP, and
wherein the neighbor node is a neighbor TRP.

7. The method of claim 6, wherein performing the carrier phase measurement together with the time difference measurement comprises:
measuring a reference carrier phase on the reference TRP using a carrier/PFL used to measure the neighbor TRP;
measuring carrier phase on the neighbor TRP using the carrier PFL used to measure the neighbor TRP; and
determining a reference signal carrier phase difference, RSCPD, measurement based on a difference between the carrier phase and the reference carrier phase.

8. The method of claim 1, wherein performing the carrier phase measurement together with the time difference measurement comprises:
failing to perform the carrier phase measurement or the time difference measurement;
requesting updated configuration information; and
reperforming the carrier phase measurement together with the time difference measurement.

9. The method of claim 1, wherein performing the operational task comprises reporting a result of performing the carrier phase measurement together with the time difference measurement.

10. The method of claim 1, wherein performing the operational task comprises determining a positioning of the communication device.

11. A method of operating a network node configured to provide a location server, the method comprising:
configuring a communication device to perform carrier phase difference measurement together with time difference measurement;
transmitting an indication of information to the communication device to be considered while performing the carrier phase difference measurement together with the time difference measurement; and
receiving a measurement report from the communication device including the carrier phase measurement performed together with the time difference measurement.

12. The method of claim 11, wherein the network node is configured to provide a location management server.

13. The method of claim 11, wherein configuring the configuration information comprises transmitting a list of potential configuration informations.

14. The method of claim 11, wherein the carrier phase measurement comprises a carrier phase difference measurement, CPDM, and wherein the time difference measurement comprises a reference signal time difference, RSTD.

15. The method of claim 11, wherein the configuration information comprises an indication of a positioning frequency layer, PFL, on which the communication device is instructed to perform the carrier phase measurement.

16. The method of claim 15, wherein the PFL comprises a single PFL that is common between a reference node and a neighbor node that is to be considered while performing the carrier phase measurement,
wherein the reference node is a reference transmission-reception point, TRP, and
wherein the neighbor node is a neighbor TRP.

17. (canceled)

18. (canceled)

19. (canceled)

20. (canceled)

21. (canceled)

22. (canceled)

23. A communication device comprising:
processing circuitry; and
memory coupled to the processing circuitry and having instructions stored therein that are executable by the processing circuitry to cause the communication device to perform operations comprising:
obtaining configuration information to perform a carrier phase measurement together with a time difference measurement;
performing the carrier phase measurement together with the time difference measurement based on the configuration information; and
performing an operational task based on the carrier phase measurement and the time difference measurement.

24. (canceled)

25. (canceled)

26. (canceled)

27. (canceled)

28. (canceled)

29. (canceled)

30. (canceled)

31. A network node comprising:
processing circuitry; and
memory coupled to the processing circuitry and having instructions stored therein that are executable by the processing circuitry to cause the network node to perform operations comprising:
configuring a communication device to perform carrier phase difference measurement together with time difference measurement;
transmitting an indication of information to the communication device to be considered while performing the carrier phase difference measurement together with the time difference measurement; and
receiving a measurement report from the communication device including the carrier phase measurement performed together with the time difference measurement.

32. (canceled)
